(19) United States
(12) Patent Application Publication
(10) Pub. No.: US 2016/0100400 A1
(43) Pub. Date: Apr. 7, 2016

(54) BEACON BASED TIME DIVISION MULTIPLEXING SYNCHRONIZATION FOR MULTIPLE RADIO ACCESS TECHNOLOGY COEXISTENCE

(71) Applicant: QUALCOMM Incorporated, San Diego, CA (US)

(72) Inventors: Jian Lu, Los Gatos, CA (US); Zhen Xie, San Jose, CA (US)

(21) Appl. No.: 14/505,670

(22) Filed: Oct. 3, 2014

(51) Int. Cl. H04W 72/04; H04W 4/00; H04W 16/14; H04W 84/12; H04W 56/00

(52) U.S. Cl. CPC H04W 72/0446; H04W 84/12; H04W 56/0015; H04W 16/14; H04W 4/008

(57) ABSTRACT

Methods, systems, and devices are described for beacon based time division multiplexing (TDM) synchronization for multiple radio access technology (RAT) coexistence. In some aspects, TDM time slots corresponding to a plurality of RATs for wireless communication among a plurality of devices may be identified, and the TDM time slots may be synchronized based at least in part on a timing beacon associated with a first of the plurality of RATs.

### FIELD OF THE DISCLOSURE

The present disclosure relates to wireless communication systems, and more particularly to beacon based time division multiplexing synchronization for multiple radio access technology (RAT) coexistence.

### BACKGROUND

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a Wireless Local Area Network (WLAN), such as a Wi-Fi network (IEEE 802.11) may include multiple wireless communication devices that communicate with one another.

Many wireless communication devices today are capable of wireless communications using multiple radio access technologies (RATs). These multiple RATs, however, may use wireless spectrum frequency bands that overlap. For example, both IEEE 802.11 and Bluetooth use the 2.4 GHz industrial, scientific, and medical (ISM) band for transmissions. In order to prevent the transmissions associated with one RAT from interfering with transmissions of the other RAT(s), a time division multiplexing (TDM) scheme can be adopted, whereby access to the shared frequency band is split into different sets of TDM timeslots, with different time slots being available for different RATs. For example, 50 ms time slots may be defined, with the first, third, fifth, etc. time slots being assigned to an IEEE 802.11 WLAN RAT, and the second, fourth, sixth, etc. time slots being assigned to a Bluetooth RAT.

### SUMMARY

The described features generally relate to improved systems, methods, or apparatuses for beacon based time division multiplexing (TDM) synchronization for multiple radio access technology (RAT) coexistence. TDM time slots may be identified for each of the multiple RATs for use by a number of wireless communication devices, and the identified time slots may be synchronized based at least in part on a timing beacon associated with a first of the multiple RATs. The identification and synchronization of the time slots may be performed by one or more of the wireless communication devices—for example, one device may define the time slots, and that same device or a different device may transmit synchronization information via a timing beacon at a predefined time during one of the time slots.

A method for wireless communication is described. The method may include identifying time division multiplexing (TDM) time slots corresponding to a plurality of radio access technologies (RATs) for wireless communication among a plurality of devices, and synchronizing the TDM time slots based at least in part on a timing beacon associated with a first RAT of the plurality of RATs.

An apparatus for wireless communication is described. The apparatus may include a time division multiplexing (TDM) coordinator to identify TDM time slots corresponding to a plurality of radio access technologies (RATs) for wireless communication among a plurality of devices, and a synchronizer to synchronize the TDM time slots based at least in part on a timing beacon associated with a first RAT of the plurality of RATs.

A further apparatus for wireless communication is described. The apparatus may include means for identifying time division multiplexing (TDM) time slots corresponding to a plurality of radio access technologies (RATs) for wireless communication among a plurality of devices, and means for synchronizing the TDM time slots based at least in part on a timing beacon associated with a first RAT of the plurality of RATs.

A non-transitory computer-readable medium for wireless communication in a wireless device is described. The non-transitory computer readable medium may store computer-executable code for identifying time division multiplexing (TDM) time slots corresponding to a plurality of radio access technologies (RATs) for wireless communication among a plurality of devices, and also for synchronizing the TDM time slots based at least in part on a timing beacon associated with a first RAT of the plurality of RATs.

In the methods, apparatuses, and non-transitory computer-readable mediums described herein, the first RAT may be a wireless local access network (WLAN) RAT, and the timing beacon may be transmitted at a target beacon transmission time (TBTT) associated with the WLAN RAT. Also, the timing beacon may be transmitted within one of the TDM time slots assigned to the WLAN RAT. The first RAT and a second RAT of the plurality of

RATs use overlapping wireless spectrum frequency bands. The first RAT may be, for example a wireless local access network (WLAN), and the second RAT may be Bluetooth. The synchronizing of the TDM time slots may be triggered upon activation of the second RAT.

The plurality of devices may form an ad hoc network in one embodiment. In another embodiment, the plurality of devices may form a service access point (SAP)-station (STA) network, and the timing beacon may be transmitted, by a service access point of the SAP-STA network, to a station of the SAP-STA network, or the timing beacon may be received, by a station of the SAP-STA network, from a service access point of the SAP-STA network. In another embodiment, the plurality of devices may form a WiFi peer-to-peer (P2P) network, and the timing beacon may be transmitted, by a group owner (GO) of the WiFi P2P network, to a P2P client of the WiFi P2P network, or the timing beacon may be received, by a P2P client of the WiFi P2P network, from a group owner (GO) of the WiFi P2P network.

Clock drift in one of the plurality of devices may be monitored, and the TDM time slots may be resynchronized if the clock drift is greater than a predefined threshold. Also, a timing synchronization function (TSF) may be completed among the plurality of devices prior to synchronizing the TDM time slots.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communications system, in accordance with various aspects of the present disclosure;

FIG. 2 shows a timing block diagram of wireless communications with multiple coexisting radio access technologies (RATs), in accordance with various aspects of the present disclosure;

FIG. 3 shows a timing block diagram of wireless communications with multiple coexisting radio access technologies (RATs), in accordance with various aspects of the present disclosure;

FIG. 4 is a flow chart illustrating an example of wireless communication, in accordance with various aspects of the present disclosure;

FIG. 5 shows a block diagram of a device configured for use in wireless communication, in accordance with various aspects of the present disclosure;

FIG. 6 shows a block diagram of another device configured for use in wireless communication, in accordance with various aspects of the present disclosure;

FIG. 7 shows a block diagram of an apparatus for use in wireless communication, in accordance with various aspects of the present disclosure;

FIG. 8 is a flow chart illustrating an example of a method for wireless communication, in accordance with various aspects of the present disclosure; and

FIG. 9 is a flow chart illustrating an example of a method for wireless communication, in accordance with various aspects of the present disclosure.

### DETAILED DESCRIPTION

The described features generally relate to improved systems, methods, apparatus, and computer program products for beacon-based time division multiplexing (TDM) synchronization for multiple radio access technology (RAT) coexistence. A number of wireless communication devices may use multiple RATs having partially or fully overlapping wireless spectrum frequency bands. Because of the possibility of interference by transmissions in the overlapping bands by coexisting radios on the same device, individual wireless communication devices may define TDM time slots during which different RATs may transmit and receive over the overlapping wireless spectrum frequency bands. The lengths of the TDM time slots allocated to each RAT traditionally vary across vendors and wireless device types. Thus, when multiple wireless devices of different types or manufactured by different vendors are connected to the same basic service set (BSS) or independent basic service set (IBSS), the TDM time slots of the wireless devices may be misaligned. For example, one of the wireless devices may transmit using WiFi while a second of the wireless devices transmits over the same band using Bluetooth. This misalignment may result in wireless devices that belong to the same network interfering with each other's transmissions, which may degrade throughput and performance for the wireless devices.

In light of these and other issues, the present disclosure provides a mechanism by which coexistence TDM time slots can be synchronized across multiple wireless devices belonging to the same network or Basic Service Set (BSS). Specifically, a timing beacon associated with a first of the RATs may be transmitted by one of the wireless devices, and the other wireless devices may receive the transmitted timing beacon to align their TDM time slots with the TDM time slots of the device that transmitted the timing beacon. In this manner, the devices may use multiple RATs to wirelessly communicate while at the same reducing or eliminating the interference associated with otherwise potentially overlapping TDM time slots.

The following description provides examples, and is not limiting of the scope, applicability, or examples set forth in the claims. Changes may be made in the function and arrangement of elements discussed without departing from the scope of the disclosure. Various embodiments may omit, substitute, or add various procedures or components as appropriate. For instance, the methods described may be performed in an order different from that described, and various steps may be added, omitted, or combined. Also, features described with respect to certain examples may be combined in other examples.

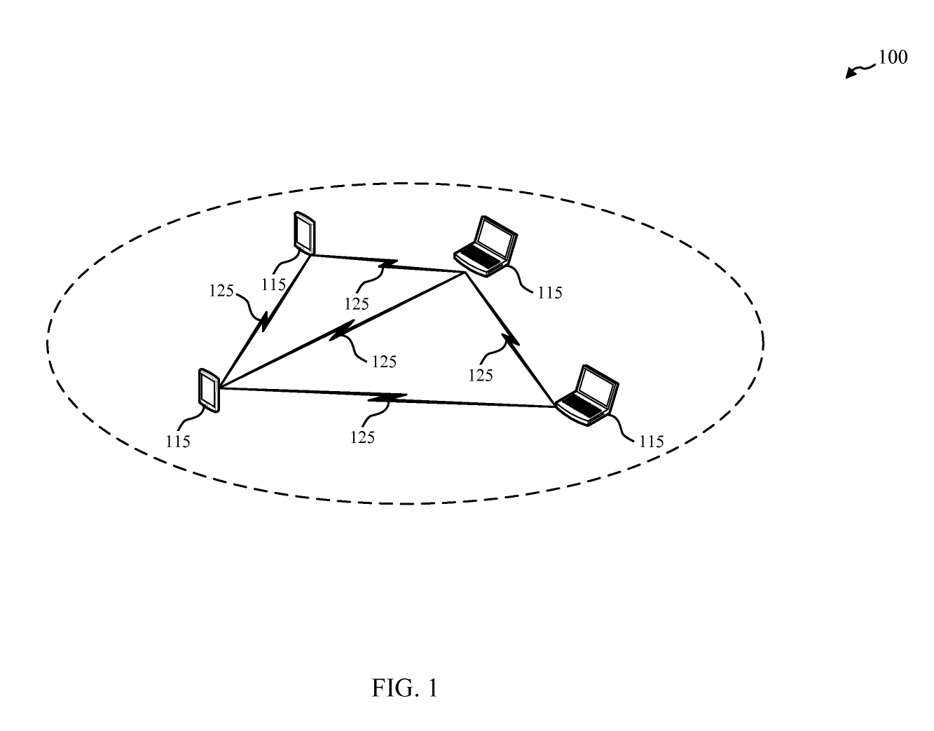

Referring first to FIG. 1, a diagram illustrates an example of a wireless communication network 100 including a number of wireless communication devices 115. The wireless communication devices 115 may include devices such as smart phones, personal digital assistants (PDAs), other handheld devices, netbooks, notebook computers, tablet computers, laptops, display devices (e.g., TVs, computer monitors, etc.), printers, etc.

Each of the wireless communication devices 115, which may also be referred to as stations (STAs), mobile stations (MSs), mobile devices, access terminals (ATs), user equipments (UEs), subscriber stations (SSs), client devices, or subscriber units, may associate and communicate with other wireless communication devices 115 via wireless communication links 125. A wireless communication device 115 can be within range of more than one wireless communication device 115 and can therefore associate with one or multiple wireless communication devices 115 at different times, or at the same time. While FIG. 1 shows an ad-hoc wireless network, the principles of the present example may also be applied to other types of wireless networks, including networks controlled by access points (AP).

Each wireless communication link 125 may be based on a radio access technology (RAT). Some wireless communication links 125 may implement a WLAN radio and baseband protocol including physical and MAC layers implementing the IEEE 802.11 family of standards, including, but not limited to, 802.11b, 802.11g, 802.11a, 802.11n, 802.11ac, 802.11 ad, 802.11 ah, etc. Other wireless communication links 125 may implement other RATs, such as Bluetooth, or generally any wireless personal area network (WPAN). Other wireless communication links 125 may be based on cellular RATs, such as long term evolution (LTE) or another cellular RAT, operating in an unlicensed band shared by the first and second RATs.

WLAN-based communication links 125 in the wireless communication network 100 may include Wi-Fi Direct connections, connections established by using a Wi-Fi Tunneled Direct Link Setup (TDLS) link, and other peer-to-peer (P2P) group connections.

For example, a first wireless communication device 115 may act as a group owner (GO) to provide service to a second wireless communication device 115 via a direct wireless communication link 125. In this scenario, the first wireless communication device 115 may function similar to an AP to the second wireless communication device 115, and the second wireless communication device 115 may be referred to as a P2P client. As another example, an ad hoc network may be formed among two or more of the wireless communication devices 115, which together may form an independent basic service set (IBSS). As still another example, one of the wireless communication devices 115 may act as a service access point (SAP), with the other wireless access points being stations (STA), forming what may be referred to as a SAP-STA network.

Bluetooth RAT based links 125 may include an object push profile (OPP) service, pairing communications, service discovery protocol (SDP) communications, and so forth. And direct wireless communication links 125 based on other RATs may similarly take many different forms, including for data transfer, control (e.g., for peripheral devices), and so forth.

As mentioned above, two or more of the RATs used in the wireless communication network 100 between wireless communication devices 115 may use partially overlapping frequency bands. For example, both IEEE 802.11 WLAN RAT based links 125 and Bluetooth RAT based links 125 may utilize a 2.4 GHz band for transmissions. Similarly, an IEEE 802.11 WLAN RAT based link 125 and an LTE-U RAT based link 125 may both utilize a 5 GHz band for transmissions. In order to accommodate the coexistence of the multiple RATs with partially or fully overlapping frequency bands, time division multiplexing (TDM) may be employed in order to allocate certain time slots to certain RATs. TDM time slots may be defined such that during a first set of time slots, the devices 115 may communicate using a first RAT, and during a second set of time slots, the devices 115 may communicate using a second RAT. Additional time slots may further be defined for third and fourth RATs, if desired. In the example with only two different RATs, alternating 50 milliseconds (ms) time slots may be assigned to the first and second RATs, such that during the first, third, fifth, etc. time slots, only the first RAT is used by the devices 115 to communicate, and during the second, fourth, sixth, etc. time slots, only the second RAT is used by the devices 115 to communicate.

The TDM time slots may be identified at the wireless communication devices 115 in one of several manners. For example, each device 115 may determine lengths for the TDM timeslots and assign certain RATs to certain time slots. As another example, the TDM time slots may be defined in a standard or by another entity. The lengths of the time slots may be configurable such that, depending on traffic or quality of service (QoS) needs of each RAT, the time slots for one RAT may be longer than the time slots for another RAT.

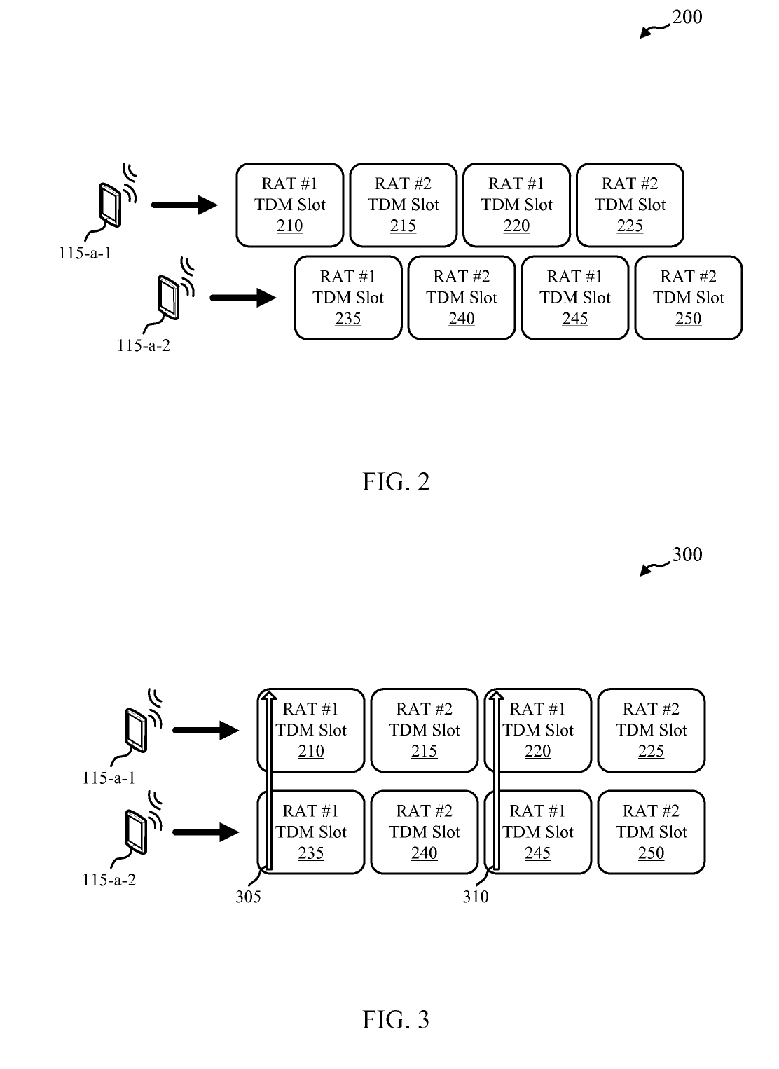

Even when using such a TDM access scheme, however, transmissions associated with different RATs may still interfere with one another if the TDM time slots are not properly aligned among the multiple devices 115, which may be the case in peer-to-peer (P2P) and other network configurations in which different wireless communication devices attempt to separately select the TDM time slots. For example, and referring now to the timing diagram 200 in FIG. 2, the TDM time slots 210, 220 for a first RAT identified by a first device 115-a-1 may not be aligned with the TDM time slots 235, 245 for the first RAT identified by a second device 115-a-2, and similarly, the TDM time slots 215, 225 for a second RAT identified by the first device 115-a-1 may not be aligned with the TDM time slots 240, 250 for the second RAT identified by the second device 115-a-2. Instead, as illustrated in FIG. 2, the TDM time slots 235, 245 for the first RAT identified by the second device may partially or entirely overlap with the TDM time slots 215, 225 for the second RAT identified by the first device. The diagram 200 in FIG. 2 may represent, for example, the time slot configuration for the first device 115-a-1 and the second device 115-a-2 following the creation of an IBSS or WiFi P2P network (or following the addition of the second device 115-a-2 to a network already including the first device 115-a-1) before TDM time slot synchronization among the first device 115-a-1 and the second device 115-a-2. FIG. 2 may represent this configuration, even if a timing synchronization function (TSF) has already been performed to synchronize the internal clocks of the first device 115-a-1 and the second device 115-a-2 together. As another example, the diagram 200 in FIG. 2 may represent the time slot configuration for a traditional access-point (AP) controlled basic services set (BSS) before timing beacons are used to synchronize the time slots among the stations (STAs) and also synchronize the time slots between the STAs and the AP itself.

In the configuration illustrated in FIG. 2, transmissions to or from the second device 115-a-2 during the TDM time slots 235, 245 associated with the first RAT may interfere with, and may receive interference from, transmissions to or from the first device 115-a-1 during the TDM time slots 215, 225 associated with the second RAT. As one example, the first RAT may be a WLAN-based WiFi network for transmitting user data (such as pictures, video, text, and so forth) between the first device 115-a-1 and the second device 115-a-2, or between one of the first device 115-a-1 or the second device 115-a-2 and another WLAN device not shown in FIG. 2. Further, the second RAT may be a Bluetooth-based RAT for transmitting control information (e.g., control of nearby peripherals or other accessories, such as a printer, monitor, headset, mouse, keyboard, and so forth) between the first device 115-a-1 and the second device 115-a-2, or between one of the first device 115-a-1 or the second device 115-a-2 and another Bluetooth device not shown in FIG. 2.

As illustrated in FIG. 2, however, the TDM time slots 210, 235, 215, 240, 220, 245, 225, 250 are misaligned between the first device 115-a-1 and the second device 115-a-2. As a result, transmissions to or from the first device 115-a-1 using the first, WLAN-based RAT may interfere with, and may be subject to interference from, transmissions to or from the second device 115-a-2 using the second, Bluetooth-based RAT. For example, if the second device 115-a-2 receives or transmits using the first, WLAN-based RAT for the entire time slot 235 it has assigned to the first RAT, transmissions in the latter half of the time slot 235 may collide with transmissions to or from the first device 115-a-1 using the second, Bluetooth-based RAT during time slot 215 it has assigned to the second RAT. Interfering transmissions may reduce the throughput of one or both RATs, may lead to increased power usage as both RATs increase power to try to overcome the interfering transmissions, and so forth.

It will be appreciated that while FIG. 2 shows an example of partially overlapping TDM time slots, in other examples, the time slots may overlap less or more, depending on how each device 115 defines the TDM time slots. In one particularly difficult case, the TDM time slots 215, 225 identified by the first device 115-a-1 for transmissions using the second RAT may entirely overlap the TDM time slots 235, 245 identified by the second device 115-a-2 for transmissions using the first RAT. In other cases, however, the TDM time slots for different RATs may overlap by a smaller amount.

Turning now to the timing diagram 300 shown in FIG. 3, in order to reduce the potential interference between transmissions using the first and second RATs, the TDM time slots for the devices 115-a-1, 115-a-2 may be synchronized based at least in part on a timing beacon 305, 310 associated with a first of the multiple RATs. The synchronization of the TDM time slots among the devices 115-a-1, 115-a-2 may be triggered in one of several different ways. In one embodiment, the TDM time slots may be synchronized based at least in part on a timing beacon 305, 310 responsive to a new network configuration of the devices 115-a-1, 115-a-2 (e.g., when one of the devices newly joins an IBSS network), in which case the synchronization may be included as one of the steps of the handshaking process by which the new device joins the network. For example, if the second device 115-a-2 joins an IBSS network already established by the first device 115-a-1, the second device 115-a-2 may use the TDM time slots defined by the first device 115-a-1 and a timing beacon from the existing IBSS network to align the TDM time slots of the second device 115-a-2 to those of the first device 115-a-1. As another example of a new network configuration, if both of the first device 115-a-1 and the second device 115-a-2 are already part of a single network, but are only using a single RAT to communicate with each other and other devices, the TDM time slot synchronization may be triggered by one of the devices 115-a-1, 115-a-2 activating a second RAT to use for wireless communication. Other types of events may also trigger the synchronization of the TDM time slots, including a monitored clock drift of either of the devices 115-a-1, 115-a-2 being greater than a predetermined threshold, an explicit request by one of the devices 115-a-1, 115-a-2 to resynchronize the TDM time slots (due to, for example, identification of throughput degradation associated with one or both of the RATs), and so forth.

The timing beacons 305, 310 may be used to synchronize the TDM time slots in one of several manners. In some instances, the timing beacons 305, 310 may include explicit information elements (IE) or other control signaling indicating to the devices 115-a-1, 115-a-2 one or more parameters needed for synchronization of the TDM time slots. In other instances, the devices 115-a-1, 115-a-2 may infer one or more parameters needed for synchronization from the timing beacons 305, 310 (such as the time at which the timing beacon is received, beacon length parameters in the timing beacon, and so forth), and thus the timing beacons 305, 310 may not include explicit synchronization information. In either example, the timing beacons 305, 310 may be associated with a specific RAT, such as the WLAN RAT. When associated with the WLAN RAT, the timing beacons 305, 310 may include basic information concerning a basic services set (BSS) or independent basic services set (IBSS) associated with the WLAN, such as whether traffic is pending for each of the devices 115-a-1, 115-a-2, beacon intervals, time stamp information, capability information, identifying information, other administrative information, and so forth.

The timing beacons 305, 310 can thus be conventional timing beacons sent by a group owner (GO) or access point (AP) of a WLAN network in some embodiments. Alternatively, however, the timing beacons 305, 310 may be separate from the conventional WLAN timing beacons, and may be specific to the present disclosure and the synchronization of TDM time slots among multiple wireless communication devices 115-a-1, 115-a-2. Generally speaking the timing beacons 305, 310 may be associated with any of the RATs in use in the network, and may be conventional timing beacons (with or without modifications) or new timing beacons defined just for the purpose of synchronizing TDM time slots as described herein.

Again referring to the example in which the timing beacons 305, 310 are associated with the WLAN RAT, in one implementation, the timing beacons 305, 310 may be transmitted at a target beacon transmission time (TBTT) of the WLAN RAT. The TBTT may be within a TDM time slot assigned to the WLAN RAT, and may be near the beginning of WLAN RAT TDM time slots 210, 220. For example, if each TDM time slot is 50 ms, then the TBTT may be 5 ms after the beginning of the WLAN RAT TDM slot, which may provide a small margin before the timing beacon is sent in order to cause the transmission of the timing beacon to be covered by the WLAN RAT TDM slot, which in turn may help avoid a stalled or missed timing beacon transmission. In other examples, however, the timing beacon may be transmitted in a time slot associated with a different RAT, or in a different position within the time slot associated with the WLAN RAT. Also, broadcast/multicast packets (including dynamic host configuration protocol (DHCP) packets) may be transmitted immediately following the timing beacon in some embodiments, which may reduce the likelihood of these packets from needing to be retransmitted.

As illustrated in FIG. 3, after synchronization, the TDM time slots 210, 220, 235, 245 assigned to the first RAT may be aligned between the first device 115-a-1 and the second device 115-a-2, and the TDM time slots 215, 225, 240, 250 assigned to the second RAT may also be aligned between the first device 115-a-1 and the second device 115-a-2. In practice one, two, or more beacon cycles may occur before the TDM time slots are properly synchronized among the wireless communication devices 115-a-1, 115-a-2. The timing diagram 300 in FIG. 3 thus illustrates the configuration of the TDM time slots after the TDM time slots have been synchronized among the devices 115-a-1, 115-a-2 using the timing beacons 305, 310.

Comparing FIGS. 2 and 3, it will be appreciated that the time slots 235, 240, 245, 250 associated with the second device 115-a-2 have been time shifted relative to the time slots 210, 215, 220, 225 associated with the first device 115-a-1 (or vice versa). Nonetheless, in certain embodiments, the devices 115-a-1, 115-a-2 may perform traffic shaping or include gap periods near the beginning and end of each time slot in order to accommodate the transition between the different RATs. It will also be appreciated that the time slots 210, 215, 220, 225, 235, 240, 245, 250 may in some examples need to be adjusted, after the initial synchronization, during operation of the devices 115-a-1, 115-a-2. For example, if the internal clocks of the devices 115-a-1, 115-a-2 have clock drift, or if the devices 115-a-1-, 115-a-2 move to different physical locations, then the TDM time slots may need to be resynchronized in order to account for the changes.

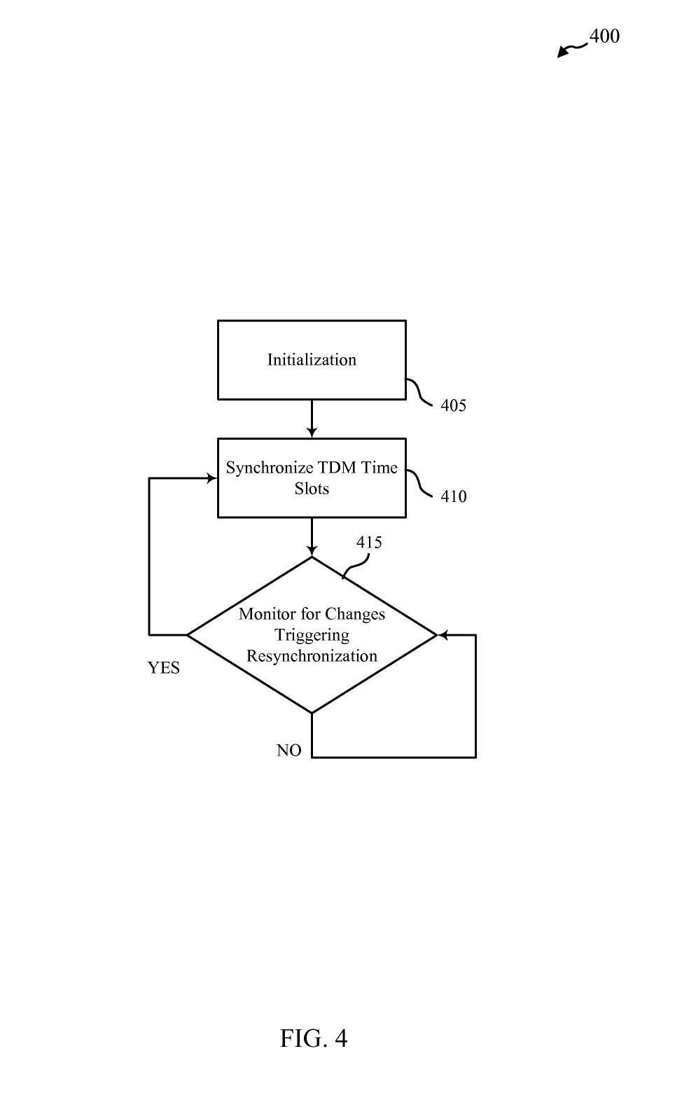

Referring to FIG. 4, a flow block diagram 400 illustrates the synchronization of TDM time slots as described above with reference to FIGS. 1-3, in accordance with various examples. At block 405, one or more initialization operations may be performed. For example, multiple wireless communication devices 115 may form a wireless communication network 100, which may be an ad hoc or IBSS network, a P2P network, a SAP-STA network, etc. A timing synchronization function (TSF) may also be completed among the plurality of devices, which may synchronize the internal clocks of the devices to one another. Additionally, at block 405, the devices 115 forming the network 100 may activate two or more different RATs for use on the network 100. The activation of two different RATs may cause the devices 115 to identify TDM time slots corresponding to the different RATs at each of the devices 115. At block 410, the TDM time slots identified by the devices 115 for use with the different RATs may be synchronized based on a timing beacon associated with one of the RATs. As described above, the TDM time slots may be synchronized based on the timing beacon by, for example, extracting explicit synchronization information from the timing beacons, or inferring implicit synchronization parameters from the timing beacons. In either example, the devices may automatically perform the TDM time slot synchronization based on the occurrence of some event, or the devices may perform the TDM time slot synchronization only when commanded to do so by another device.

At block 415, the devices 115 may monitor for changes that trigger resynchronization—for example, if clock drift greater than a predefined threshold is detected in one of the devices, if a new device joins the network 100, if there are reports of interference or congestion among the different RATs, and so forth. In some examples, one change that may trigger resynchronization may be the expiration of a timer, which may cause the TDM time slots to be periodically resynchronized regardless of any other events. If the devices 115 detect no changes triggering the resynchronization, then the devices 115 may continue to monitor for changes at block 415. If the devices 115 do detect a change triggering resynchronization, the TDM time slots may again be synchronized at block 410 in a manner similar to that described above.

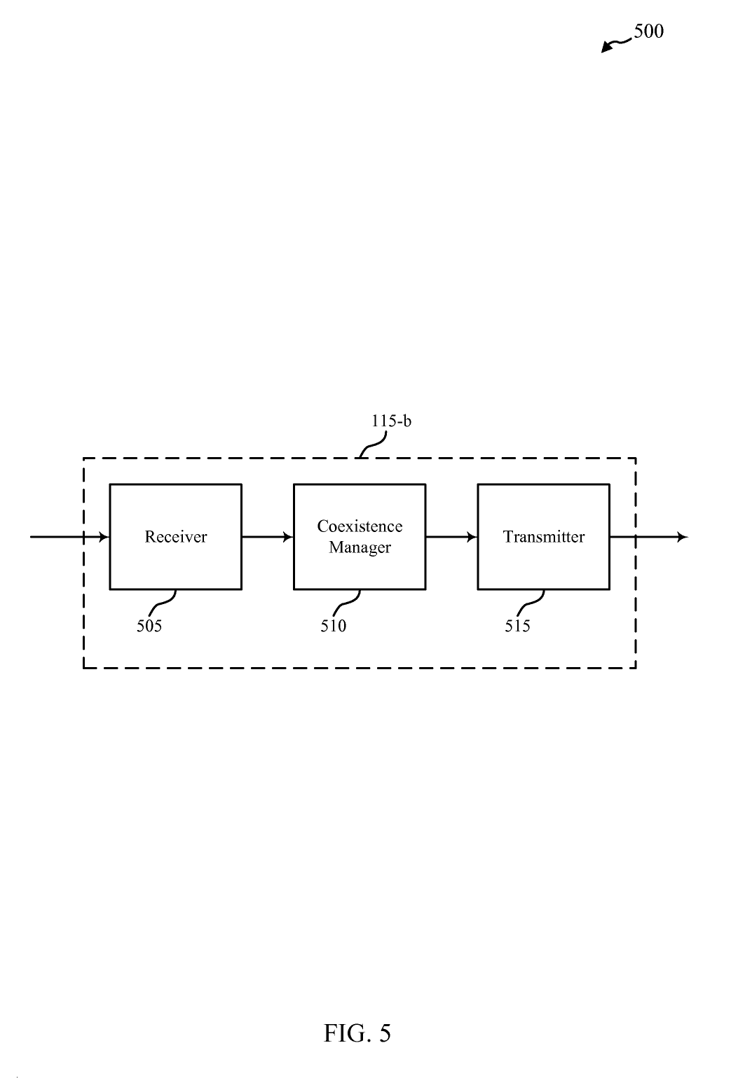

FIG. 5 shows a block diagram 500 of a wireless communication device 115-b for use in a wireless communication network, in accordance with various aspects of the present disclosure. The device 115-b may be an example of aspects of the devices 115 described above with reference to FIGS. 1-4. The device 115-b may also be or include a processor (not shown). The device 115-b may include a receiver 505, a coexistence manager 510, and a transmitter 515. Each of these components may be in communication with each other. The device 115-b, through the receiver 505, the coexistence manager 510, and the transmitter 515, may be configured to perform functions described herein.

The components of the device 115-b may, individually or collectively, be implemented using application-specific integrated circuits (ASICs) adapted to perform some or all of the applicable functions in hardware. Alternatively, the functions may be performed by other processing units (or cores), on integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each component may also be implemented, in whole or in part, with instructions embodied in a memory, formatted to be executed by general or application-specific processors.

The receiver 505 may receive information such as packets, user data, or control information associated with various information channels (e.g., control channels, data channels, etc.). The receiver 505 may thus receive a timing beacon transmitted by another wireless device, other information regarding TDM time slots, and so forth.

Information received by the receiver 505 may be passed on to the coexistence manager 510, and to other components of the device 115-b. The coexistence manager 510 may be configured to identify TDM time slots corresponding to a number of RATs for wireless communication with other devices, and also to synchronize the TDM time slots based on a timing beacon associated with a first of the RATs.

The transmitter 515 may transmit signals received from other components of the device 115-b. For example, the transmitter 515 may transmit a timing beacon to other wireless communication devices.

In some examples, each device within a network (e.g. the network 100 in FIG. 1) may include a receiver 505, a coexistence manager 510, and a transmitter 515, as shown in FIG. 5. In each specific implementation, however, different components may take on different roles. For example, the coexistence manager 510 and transmitter 515 of a group owner (GO) of a WiFi P2P network may generate and transmit the timing beacons described above, and the coexistence manager 510 may synchronize defined TDM time slots based on the transmitted timing beacons. The coexistence manager 510 of P2P clients in the WiFi P2P network, however, may synchronize its TDM time slots based on the timing beacons received from the GO. In this manner, some devices in the network may provide instructions that other devices receive, process, and implement.

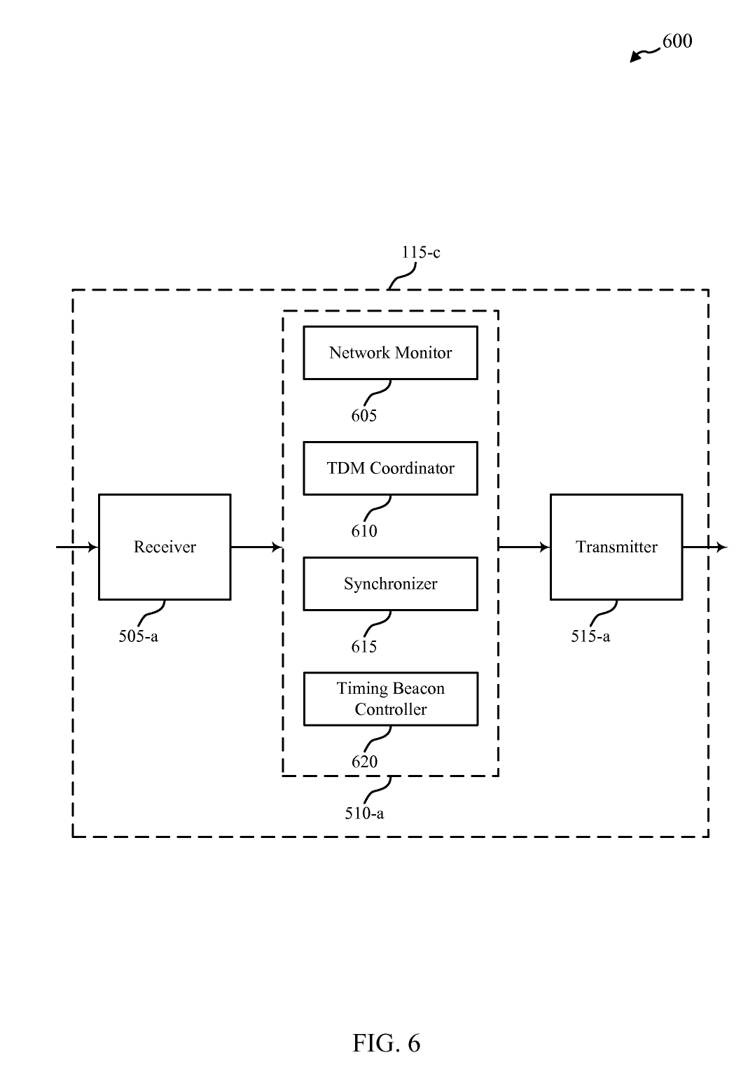

FIG. 6 shows a block diagram of a wireless communication device 115-c for use in wireless communication, in accordance with various examples. The device 115-c may be an example of aspects of the devices 115 described above with reference to FIGS. 1-5. The device 115-c may include a receiver 505-a, a coexistence manager 510-a, and a transmitter 515-a, which may be examples of the corresponding components of the device 115-b shown in FIG. 5. The device 115-c may be or include a processor (not shown). Each of these components may be in communication with each other. The receiver 505-a and the transmitter 515-a may perform the functions of the receiver 505 and transmitter 515 of FIG. 5, respectively. The coexistence manager 510-a may include a network monitor 605, a TDM coordinator 610, a synchronizer 615, and a timing beacon controller 620.

The network monitor 605 of the coexistence manager 510-a in FIG. 6 may be configured to monitor a wireless communication network (e.g., the network 100 in FIG. 1) for changes that may trigger a (re)synchronization of TDM time slots, such as a new device joining, activation of a RAT, clock drift in one of the devices exceeding a predefined threshold, etc. Upon detecting an event requiring a (re)synchronization, the network monitor 605 may communicate the need to (re)synchronize to the other components of the coexistence manager 510-a. The network monitor 605 may also be configured to complete a timing synchronization function (TSF) with other wireless communication devices before the TDM time slots are synchronized as described herein, which may provide a synchronized internal, baseline clock for the devices, against which the TDM time slots can be properly synchronized.

The TDM coordinator 610 of the coexistence manager 510-a in FIG. 6 may be configured to identify TDM time slots associated with different RATs, for example, by defining the length and RAT assignment for each time slot. The TDM coordinator 610 may identify the TDM time slots based on data stored in the TDM coordinator (e.g., specifications from an industry standard), based on TDM time slot information received from other devices (which may or may not be include in the timing beacons 305, 310 in FIG. 3), traffic needs for the different RATs as identified by the device 115-c, based on information obtained from other components of the device 115-c, and so forth. As previously mentioned, the relative sizes of the TDM time slots may be dynamically adjusted in some embodiments to account for varying amounts of traffic on the different RATs. For example, if the first RAT is a WLAN-based RAT, and video data is being transmitting using the WLAN-based RAT, while the second RAT is a Bluetooth-based RAT, and relatively small amounts of control data is being transmitting using the Bluetooth-based RAT, then the TDM time slot for the WLAN RAT may be larger than the TDM time slot for the Bluetooth RAT. If, however, at a later time, the video data transmissions finishes and relatively little data needs to be transmitted using the WLAN RAT, and a device requests access to the Bluetooth RAT to transmit a compressed file or audio information, then the length of the Bluetooth RAT may be increased relative to the length of the WLAN RAT.

The synchronizer 615 of the coexistence manager 510-a in FIG. 6 may be configured to synchronize the TDM time slots based on information received from the timing beacon controller 620, described below, or to provide synchronization information to the timing beacon controller for transmission to other wireless communication devices via a timing beacon, depending on the role of the device 115-c in the network. For example, the synchronizer 615 may be configured to align the TDM time slots identified by the device 115-c with TDM time slots of other devices if the device 115-c is a P2P client, or alternatively may be configured to provide alignment information for use by other devices to align their TDM time slots with the TDM time slots identified by the device 115-c if the device 115-c is a P2P GO. The synchronizer 615 may also be configured to align the TDM time slots identified by the device 115-c with TDM time slots of other devices when the device 115-c is a station (STA), or to provide alignment information for use by other devices to align their TDM time slots with the TDM time slots identified by the device 115-c when the device 115-c is a service access point (SAP). When the device 115-c is in an IBSS node, the synchronizer 615 may be configured to align the TDM time slots identified by the device 115-c with TDM time slot synchronization information received from other devices or, if no timing beacon is detected by the device 115-c, may be configured to transmit a timing beacon to other devices on the IBSS for them to synchronize their TDM time slots to the TDM time slots of the device 115-c.

The timing beacon controller 620 of the coexistence manager 510-a in FIG. 6 may be configured to receive timing beacons transmitted by other devices or configured to transmit a timing beacon from the device 115-c. As described above, the coexistence manager 510-a may be configured to synchronize TDM time slots based on a timing beacon associated with one RAT, and, as such, the timing beacon controller 620 may be configured to receive or transmit timing beacons in order to accomplish the synchronization of the TDM time slots. The timing beacon transmitted by the timing beacon controller (via the transmitter 515-a) may include control information, such as a beacon length and synchronization information interpretable by other wireless communication devices to synchronize their TDM time slots to the timing beacon transmitted by the device 115-c. The timing beacon controller 620 may thus dictate the content and transmission time of the timing beacon—for example, the timing beacon controller may cause the timing beacon to be transmitted (via the transmitter 515-a) at a target beacon transmission time (TBTT) associated with a WLAN RAT, or the timing beacon controller may cause the timing beacon to be transmitted within one of the TDM timeslots assigned to the WLAN RAT.

In those embodiments in which multiple wireless communication devices form an ad hoc or IBSS network, the timing beacon controller 620 may be configured to attempt to transmit the timing beacon at a target beacon transmission time (TBTT) to other devices, and also configured to listen for transmitted timing beacons from others of the plurality of devices. In this manner, each device may contend at the TBTT to send the timing beacon, while also listening for possible timing beacons sent by other devices.

In those embodiments in which multiple wireless communication devices form a SAP-STA network, the timing beacon controller 620 may be configured to transmit the timing beacon to stations of the SAP-STA network when the device 115-c is a SAP of the SAP-STA network. The timing beacon controller 620 may additionally or alternatively be configured to receive the timing beacon from a SAP when the device 115-c is a STA of the SAP-STA network.

In those embodiments in which multiple wireless communication devices form a WiFi peer-to-peer (P2P) network, the timing beacon controller 620 may be configured to transmit the timing beacon to P2P clients of the WiFi P2P network when the device 115-c is a group owner (GO). The timing beacon controller 620 may additionally or alternatively be configured to receive the timing beacon from a GO when the device 115-c is a P2P client.

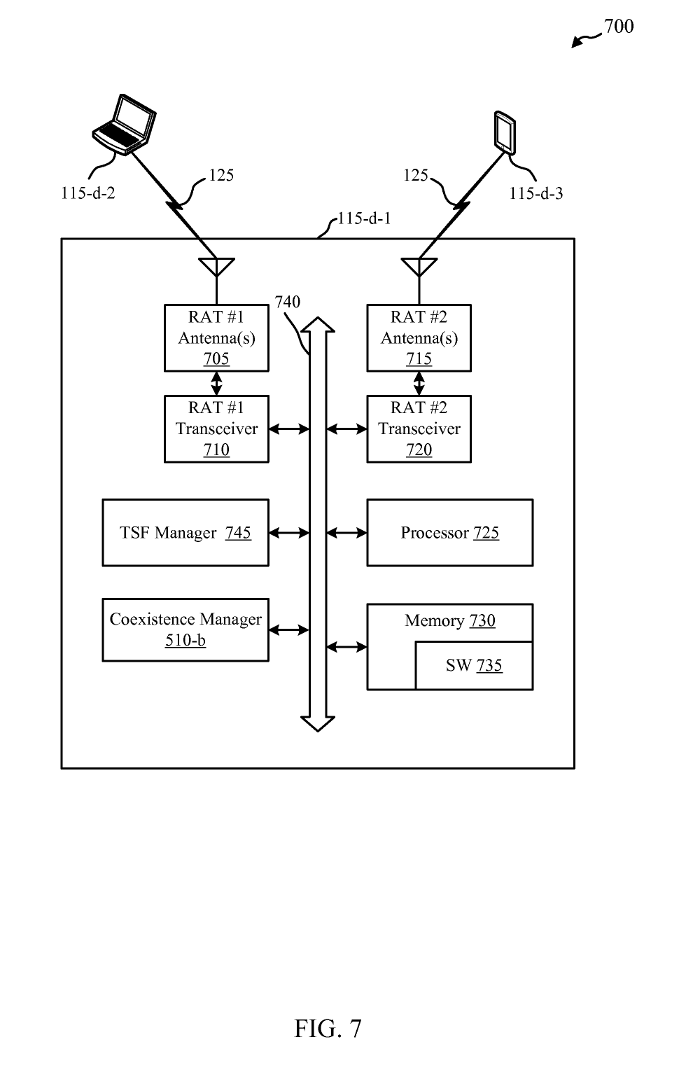

Turning to FIG. 7, a block diagram 700 is shown that illustrates a wireless communication device 115-d-1 configured to wirelessly communicate with other wireless communication devices 115-d-2, 115-d-3. The devices 115-d-1, 115-d-2, 115-d-3 may be an example of aspects of the devices 115 described above with reference to FIGS. 1-6.

The wireless communication device 115-d-1 may include a first antenna 705 and first transceiver 710 for sending or receiving transmissions based on a first RAT (e.g., for communications with a second wireless communication device 115-d-2). The wireless communication device 115-d-1 in FIG. 7 may also include a second antenna 715 and second transceiver 720 for sending or receiving transmissions based on a second RAT (e.g., for communications with a third wireless communication device 115-d-3). In some cases, device 115-d-1 may include a single antenna and single transceiver, but in other devices, it may include separate antennas and transceivers as illustrated in FIG. 7. The wireless communication device 115-d-1 also includes a processor 725, a memory 730, a TSF manager 745, and a coexistence manager 510-b. The coexistence manager 510-b may be an example of aspects of the coexistence managers 510 described above with reference to FIGS. 4 and 5. Each of these components may be in communication with each other, directly or indirectly, over a bus 740.

The memory 730 may include RAM and ROM. The memory 730 may store computer-readable, computer-executable software (SW) code 735 containing instructions that are configured to, when executed, cause the processor 725 or other components of the device 115-d-1 to perform various functions described herein. Alternatively, the software code 735 may not be directly executable by the processor 725 but may be configured to cause the computer (e.g., when compiled and executed) to perform functions described herein.

The processor 725 may include an intelligent hardware device, e.g., a CPU, a microcontroller, an ASIC, etc. The processor 725 may process information received from other components of the device 115-d-1 and provide results to other components of the device 115-d-1.

The wireless communication device 115-d-1 illustrated in FIG. 7 may be configured to communicate bi-directionally with other wireless communication devices 115-d-2, 115-d-3 via antennas 705, 715 and transceivers 710, 720. To this end, each of the transceivers 710, 720 may include respective modems configured to modulate the packets and provide the modulated packets to the antennas 705, 715 for transmission according to their respective RAT, and also to demodulate packets received from the antennas 705, 715. While FIG. 7 shows each transceiver 710, 720 associated with a single respective antenna 705, 715, in other embodiments, multiple antennas may be associated with each transceiver 710, 720.

According to the architecture of FIG. 7, the coexistence manager 510-b may be configured to identify and synchronize TDM time slots based on timing beacons as described herein. Further, the timing synchronization function (TSF) manager 745 may be configured to complete a hardware-based TSF relative to other wireless communication devices 115-d-2, 115-d-3 prior to the identification or synchronization of the TDM time slots by the coexistence manager 510-b. In this manner, the TSF manager may provide a baseline clock among multiple wireless communication devices 115-d-1, 115-d-2, 115-d-3 against which the TDM time slots can be properly synchronized.

The components of the device 115-d-1 may be configured to implement aspects discussed above with respect to FIGS. 1-6 and those aspects may not be repeated here for the sake of brevity. Also, while FIG. 7 illustrates some of the components of the first wireless communication device 115-d-1, it will be understood that the other wireless communication devices 115-d-2, 115-d-3 in FIG. 7 may have similar or identify components as the first wireless communication device 115-d-1. Nonetheless, the second or third wireless communication devices 115-d-2, 115-d-3 may alternatively include fewer or different components—for example, the second wireless communication device 115-d-2 may only include components for communication using the first RAT (and not the second RAT), or the third wireless communication device 115-d-3 may only include components for communication using the second RAT (and not the first RAT).

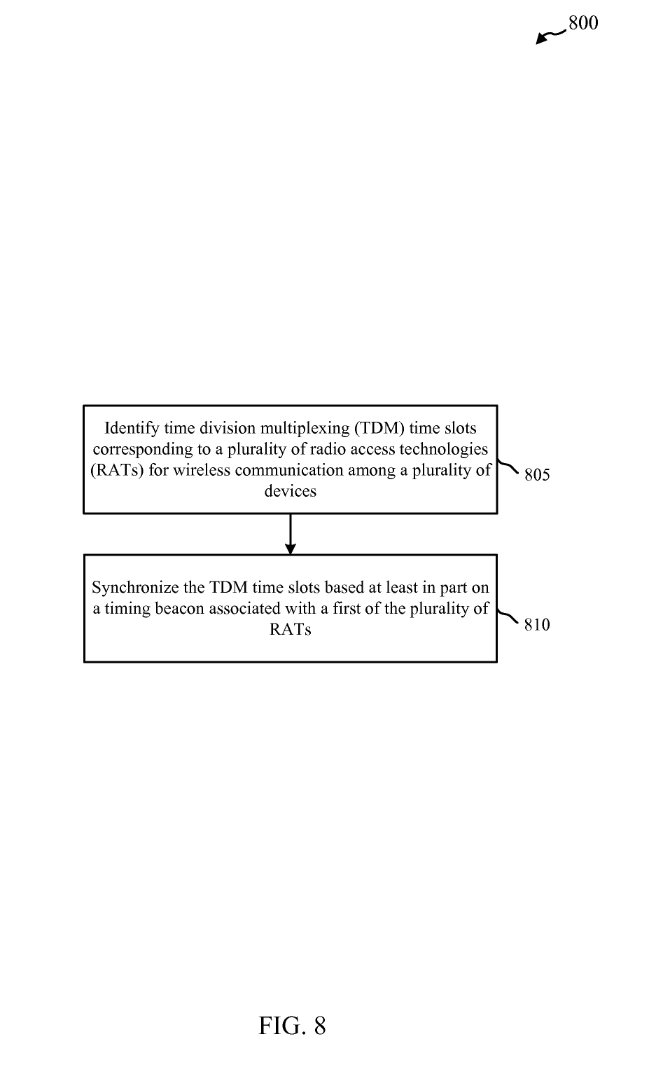

FIG. 8 is a flow chart illustrating an example of a method 800 for wireless communication, in accordance with various aspects of the present disclosure. For clarity, the method 800 is described below with reference to aspects of the wireless communication devices 115 described above with reference to FIGS. 1-7. A wireless communication device may execute code to control the functional elements of the device to perform the functions described below. Additionally or alternatively, a wireless communication device may perform the functions described below using special-purpose hardware.

At block 805, the method 800 may include identifying time division multiplexing (TDM) time slots corresponding to a plurality of radio access technologies (RATs) for wireless communication among a plurality of devices. At block 820, the method 800 may include synchronizing the TDM time slots among the plurality of devices based on a timing beacon associated with a first of the plurality of RATs.

Thus, the method 800 may provide for wireless communication. It should be noted that the method 800 is just one implementation and that the operations of the method 800 may be rearranged or otherwise modified such that other implementations are possible.

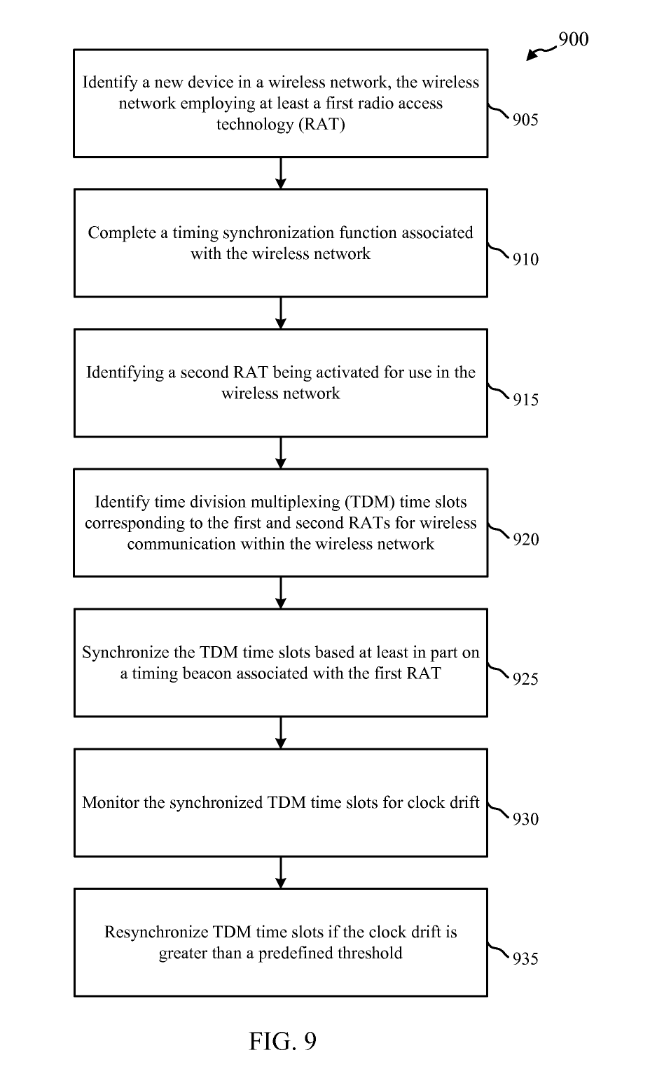

FIG. 9 is a flow chart illustrating an example of a method 900 for wireless communication, in accordance with various aspects of the present disclosure. For clarity, the method 900 is described below with reference to aspects of the wireless communication devices 115 described above with reference to FIGS. 1-7 or the wireless communication network 100 described above with reference to FIG. 1. A wireless communication device may execute code to control the functional elements of the device to perform the functions described below. Additionally or alternatively, the wireless communication device may perform the functions described below using special-purpose hardware.

At block 905, the method 900 may include identifying a new device in a wireless network, the wireless network employing a first radio access technology (RAT). At block 910, the method 900 may include completing a timing synchronization function (TSF) associated with the wireless network—for example, all of the devices in the wireless network may complete the TSF. At block 915, the method 900 may include identifying a second RAT being activated for use in the wireless network by one or more of the devices in the network.

At block 920, the method 900 may include identifying time division multiplexing (TDM) time slots corresponding to the first and second RATs for wireless communication within the wireless network. At block 925, the method 900 may include synchronizing the TDM time slots based at least in part on a timing beacon associated with the first RAT.

At block 930, the method 900 may include monitoring the synchronized TDM time slots for clock drift, and at block 935, the method 900 may include resynchronizing the TDM time slots if the clock drift monitored at block 930 is greater than a predefined threshold.

Thus, the method 900 may provide for wireless communication. It should be noted that the method 900 is just one implementation and that the operations of the method 900 may be rearranged or otherwise modified such that other implementations are possible.

Aspects from both of the methods 800, 900 may be combined. It should be noted that the methods 800, 900 are just example implementations, and that the operations of the methods 800, 900 may be rearranged or otherwise modified such that other implementations are possible.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “or,” when used in a list of two or more items, means that any one of the listed items can be employed by itself, or any combination of two or more of the listed items can be employed. For example, if a composition is described as containing components A, B, or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method for wireless communication, comprising:
identifying time division multiplexing (TDM) time slots corresponding to a plurality of radio access technologies (RATs) for wireless communication among a plurality of devices; and
synchronizing the TDM time slots based at least in part on a timing beacon associated with a first RAT of the plurality of RATs.

2. The method of claim 1, wherein the first RAT is a wireless local access network (WLAN) RAT, further comprising:
transmitting the timing beacon at a target beacon transmission time (TBTT) associated with the WLAN RAT.

3. The method of claim 2, further comprising:
transmitting the timing beacon within one of the TDM time slots assigned to the WLAN RAT.

4. The method of claim 1, wherein the first RAT and a second RAT of the plurality of RATs use overlapping wireless spectrum frequency bands.

5. The method of claim 4, wherein the first RAT is a wireless local access network (WLAN) and the second RAT is Bluetooth.

6. The method of claim 4, further comprising:
triggering the synchronizing of the TDM time slots upon activation of the second RAT.

7. The method of claim 1, wherein the plurality of devices form an ad hoc network.

8. The method of claim 1, wherein the plurality of devices form a service access point (SAP)-station (STA) network, further comprising:
transmitting, by a service access point of the SAP-STA network, the timing beacon to a station of the SAP-STA network.

9. The method of claim 1, wherein the plurality of devices form a service access point (SAP)-station (STA) network, further comprising:
receiving, by a station of the SAP-STA network, the timing beacon from a service access point of the SAP-STA network.

10. The method of claim 1, wherein the plurality of devices form a WiFi peer-to-peer (P2P) network, further comprising:
transmitting, by a group owner (GO) of the WiFi P2P network, the timing beacon to a P2P client of the WiFi P2P network.

11. The method of claim 1, wherein the plurality of devices form a WiFi P2P network, further comprising:
receiving, by a P2P client of the WiFi P2P network, the timing beacon from a group owner (GO) of the WiFi P2P network.

12. The method of claim 1, further comprising:
monitoring clock drift in one of the plurality of devices; and
resynchronizing the TDM time slots if the clock drift is greater than a predefined threshold.

13. The method of claim 1, further comprising:
completing a timing synchronization function (TSF) among the plurality of devices prior to synchronizing the TDM time slots.

14. An apparatus for wireless communication, comprising:
a time division multiplexing (TDM) coordinator to identify TDM time slots corresponding to a plurality of radio access technologies (RATs) for wireless communication among a plurality of devices; and
a synchronizer to synchronize the TDM time slots based at least in part on a timing beacon associated with a first RAT of the plurality of RATs.

15. The apparatus of claim 14, wherein the first RAT is a wireless local access network (WLAN) RAT, further comprising:
a timing beacon controller to transmit the timing beacon at a target beacon transmission time (TBTT) associated with the WLAN RAT within one of the TDM time slots assigned to the WLAN RAT.

16. The apparatus of claim 14, wherein the first RAT and a second RAT of the plurality of RATs use overlapping wireless spectrum frequency bands.

17. The apparatus of claim 16, wherein the first RAT is a wireless local access network (WLAN) and the second RAT is Bluetooth.

18. The apparatus of claim 16, further comprising:
a network monitor to trigger the synchronizing of the TDM time slots upon activation of the second RAT.

19. The apparatus of claim 14, further comprising:
a network monitor to monitor clock drift in one of the plurality of devices and trigger resynchronization of the TDM time slots if the clock drift is greater than a predefined threshold.

20. The apparatus of claim 14, further comprising:
a timing synchronization function (TSF) manager to perform a TSF among the plurality of devices prior to synchronizing the TDM time slots.

21. An apparatus for wireless communication, comprising:
means for identifying time division multiplexing (TDM) time slots corresponding to a plurality of radio access technologies (RATs) for wireless communication among a plurality of devices; and
means for synchronizing the TDM time slots based at least in part on a timing beacon associated with a first RAT of the plurality of RATs.

22. The apparatus of claim 21, wherein the first RAT is a wireless local access network (WLAN) RAT, further comprising:
means for transmitting the timing beacon at a target beacon transmission time (TBTT) associated with the WLAN RAT within one of the TDM time slots assigned to the WLAN RAT.

23. The apparatus of claim 21, wherein the first RAT and a second RAT of the plurality of RATs use overlapping wireless spectrum frequency bands.

24. The apparatus of claim 23, wherein the first RAT is a wireless local access network (WLAN) and the second RAT is Bluetooth.

25. The apparatus of claim 23, further comprising:
means for triggering the synchronizing of the TDM time slots upon activation of the second RAT.

26. The apparatus of claim 21, further comprising:
means for monitoring clock drift in one of the plurality of devices; and
means for triggering resynchronization of the TDM time slots if the clock drift is greater than a predefined threshold.

27. A non-transitory computer-readable medium for wireless communication in a wireless device, the non-transitory computer-readable medium storing computer-executable code for:
identifying time division multiplexing (TDM) time slots corresponding to a plurality of radio access technologies (RATs) for wireless communication among a plurality of devices; and
synchronizing the TDM time slots based at least in part on a timing beacon associated with a first RAT of the plurality of RATs.

28. The computer-readable medium of claim 27, wherein the first of the plurality of RATs is a wireless local access network (WLAN) RAT, and the computer-readable medium further stores computer-executable code for:
transmitting the timing beacon at a target beacon transmission time (TBTT) associated with the WLAN RAT within one of the TDM time slots assigned to the WLAN RAT.

29. The computer-readable medium of claim 27, wherein the first RAT and a second RAT of the plurality of RATs use overlapping wireless spectrum frequency bands.

30. The computer-readable medium of claim 29, wherein the computer-readable medium further stores computer-executable code for:
triggering synchronization of the TDM time slots upon activation of the second RAT.
